(19) United States
(12) Patent Application Publication
(10) Pub. No.: US 2014/0118303 A1
(43) Pub. Date: May 1, 2014

(54) LIGHT EMITTING DIODE BLACKBOARD

(71) Applicant: Hon Hai Precision Industry Co., Ltd., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 13/968,436

(22) Filed: Aug. 16, 2013

(30) Foreign Application Priority Data
Oct. 30, 2012 (TW) 101140055

(51) Int. Cl. G09G 5/10

(52) U.S. Cl. CPC G09G 5/10
USPC 345/175

(57) ABSTRACT

A light emitting diode blackboard includes a lighting pen, a driving device, and a plurality of pixels arranged in a matrix. Each of the pixels includes first, second and third light sources and a light detecting device. The light detecting device detects light from the lighting pen and generates a control signal to the driving device. The driving device turns on at least one of the first, second and third light sources according to the control signal. When the lighting pen is moving on the matrix of the pixels, the driving device sequentially turns on the at least one of the first, second and third light sources of each of the pixels on the track of the lighting pen to show the track of the lighting pen on the light emitting diode blackboard.

### BACKGROUND

1. Technical Field

The disclosure generally relates to an electronic blackboard, and particularly to a light emitting diode blackboard which can provide a number of colors for the written words/marks and whose brightness is automatically adjustable according to the environmental brightness.

2. Description of Related Art

In a traditional blackboard, a lot of dust is generated when writing words/marks on or erasing words/marks from the traditional blackboard. The dust not only pollutes the environments, but also is harmful to the user.

What is needed, therefore, is a light emitting diode (LED) blackboard to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an illustrating view showing a light emitting diode blackboard in accordance with a first embodiment of the present disclosure.

FIG. 2 is an enlarged view of a part of the light emitting diode blackboard in FIG. 1.

FIG. 3 shows an operation process of the light emitting diode blackboard in FIG. 1.

FIG. 4 is an illustrating view showing a light emitting diode blackboard in accordance with a second embodiment of the present disclosure.

### DETAILED DESCRIPTION

Embodiments of a light emitting diode blackboard will now be described in detail below and with reference to the drawings.

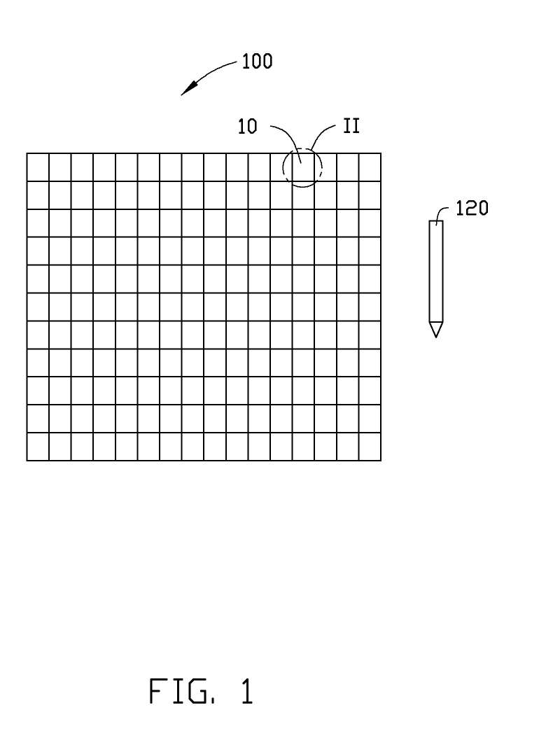

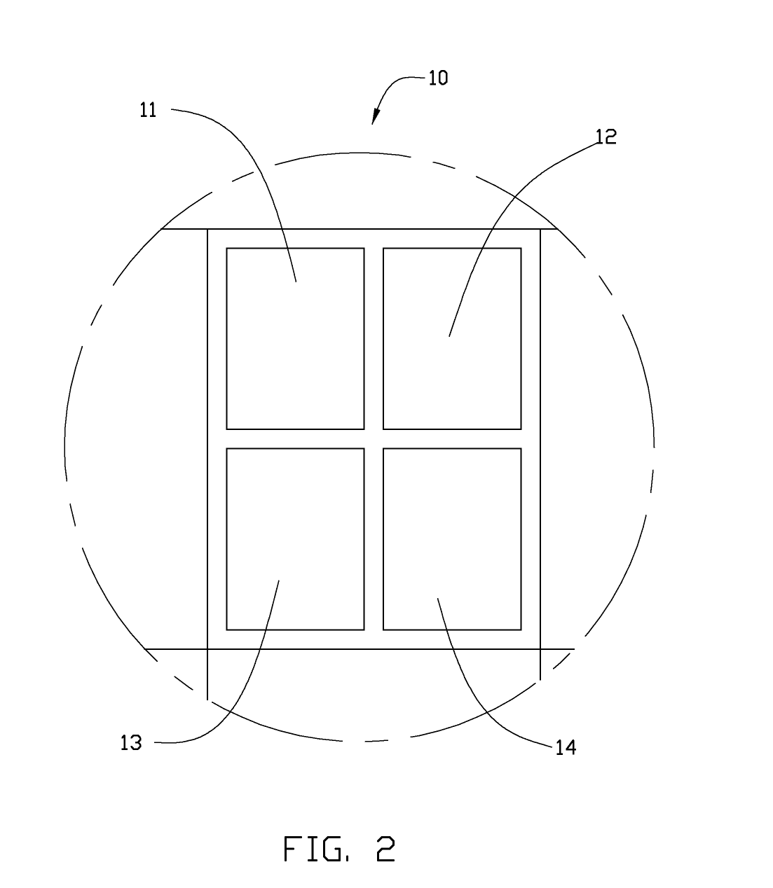

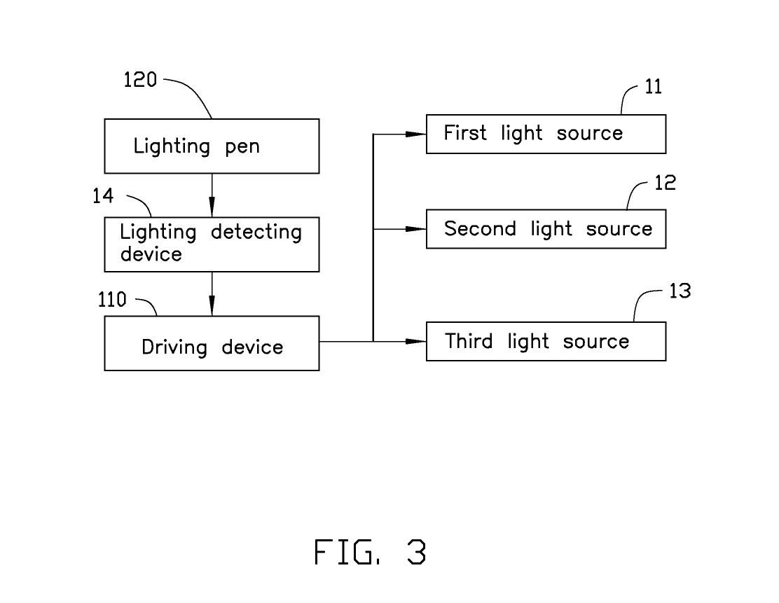

Referring to FIGS. 1-3, an LED blackboard 100 in accordance with a first embodiment is provided. The LED blackboard 100 includes a plurality of pixels 10 arranged in a matrix, a driving device 110, and a lighting pen 120. The number of the pixels 10 is determined by an area of the LED blackboard 100. An increase of the number of the pixels 10 will improve a viewing quality of the LED blackboard 100.

Each of the pixels 10 includes a first light source 11, a second light source 12, a third light source 13 and a light detecting device 14. The first light source 12 emits red light, the second light source 13 emits green light and the third light source 14 emits blue light. The light detecting device 14 receives light from the lighting pen 120 and controls lighting of the first light source 11, the second light source 12 and the third light source 13. After the light detecting device 14 receives the light from the lighting pen 120, the light detecting device 14 generates a control signal to the driving device 110. The driving device 110 turns on the first light source 11, the second light source 12 or the third light source 13 according to the control signal. For example, when the light detecting device 14 receives red light, the driving device will turn on the first light source 11 to emit red light; when the light detecting device 14 receives green light, the driving device 110 will turn on the second light source 12 to emit green light; when the light detecting device 14 receives blue light, the driving device 110 will turn on the third light source 13 to emit blue light. In addition, according to the color of light received by the light detecting device 14, the driving device 110 can selectively turn on at least one of the first light source 11, the second light source 12 and the third light source 13. For example, when the light detecting device 14 receives a white light, the driving device 110 will turn on all of the first light source 11, the second light source 12, and the third light source 13 to emit a white light. In this embodiment, the lighting pen 120 acts as a writing instrument for the LED blackboard 100.

When the lighting pen 120 moves on the LED blackboard 100, the pixels 10 on the track of the movement of the lighting pen 120 will emit light. Therefore, the track will be illustrated on the LED blackboard 100 to form the written words/marks. It means that a user can write or draw on the LED blackboard 100. In addition, by using the first light source 11, the second light source 12, and the third light source 13, the track can be illustrated in multiple colors.

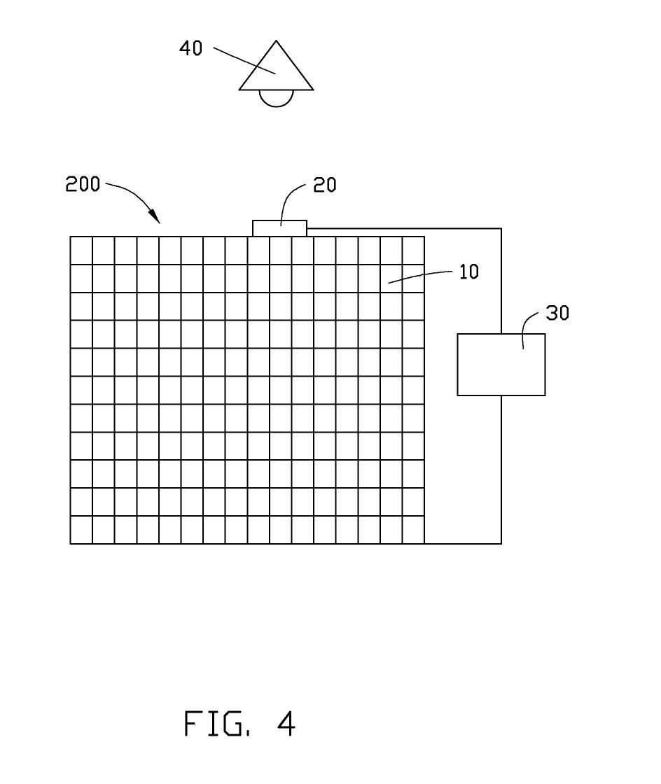

Referring to FIG. 4, an LED blackboard 200 in accordance with a second embodiment is provided. Different from the first embodiment, the LED blackboard 200 further includes a sensor 20 and a control device 30. A plurality of pixels 10 are arranged in a matrix. The sensor 20 is formed at an edge of the matrix formed by the pixels 10. The control device 30 is connected between the sensor 20 and the pixels 10. The sensor 20 detects a lighting intensity of the outer environment caused by the light source 40, and transmits information of the detected lighting intensity to the control device 30. According to the detected lighting intensity of the outer environment, the control device 30 will control a lighting intensity of the pixels 10 to make the lighting of the pixels 10 be best clearly seen in the present condition of brightness of the outer environment. Generally, the sensor 20 is formed on an upper edge of the LED blackboard 200 to optimally receive the light from the light source 40.

As described above, the LED blackboard 100 (200) shows the written words/marks according to the track of the lighting pen 120 thereon. No dust is generated in the writing process. In addition, the pixels 10 includes the first light source 11, the second light source 12 and the third light source 13 emitting light with different colors. Therefore the track can be illustrated in multiple colors. Moreover, since the lighting intensity of the pixels 10 is capable of being automatically adjusted according to the lighting intensity of the environment, the lighting of the pixels 10 can be more clearly seen without a manual adjustment of the brightness of the LED blackboard 100 (200) which sometimes is inconvenient and laborious.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light emitting diode blackboard, comprising:
a lighting pen;
a driving device; and
a plurality of pixels arranged in a matrix, each of the pixels comprising a first light source and a light detecting device, the light detecting device detecting light from the lighting pen and generating a control signal to the driving device according to the detected light, the driving device turning on the first light source according to the control signal, wherein when the lighting pen is moving on the matrix of the pixels, the driving device sequentially turning on the first light sources of the pixels on the track of the lighting pen, the turned on first light sources showing the track of the lighting pen on the light emitting diode blackboard.

2. The light emitting diode blackboard of claim 1, wherein each of the pixels further comprises a second light source and a third light source, the driving device selectively turning on at least one of the first light source, the second light source and the third light source according to the control signal.

3. The light emitting diode blackboard of claim 2, wherein a color of the light emitted by the at least one of the first light source, the second light source and the third light source is the same as the light emitted by the lighting pen.

4. The light emitting diode blackboard of claim 2, wherein the first light source emits red light, the second light source emits green light and the third light source emits blue light.

5. The light emitting diode blackboard of claim 4, wherein all of the first light source, the second light source and the third light source are turned on when the lighting pen emits white light.

6. The light emitting diode blackboard of claim 2, wherein the first light source, the second light source, the third light source and the light detecting device are arranged in a matrix.

7. The light emitting diode blackboard of claim 1, further comprising a sensor and a control device, the sensor detecting a lighting intensity of an outer environment, the control device controlling a lighting intensity of the pixels according to the lighting intensity of the outer environment.

8. The light emitting diode blackboard of claim 1, wherein the sensor is formed on an upper end of the matrix formed by the pixels to detect a light intensity from a light source located above the light emitting diode blackboard.
